(19) United States
(12) Patent Application Publication
(10) Pub. No.: US 2019/0378094 A1
(43) Pub. Date: Dec. 12, 2019

(54) DATA ANALYTICS FRAMEWORK FOR IDENTIFYING A SAVINGS OPPORTUNITY FOR SELF-FUNDED HEALTHCARE PAYERS

(71) Applicant: Wellnecity, LLC, Winston-Salem, NC (US)

(72) Inventor: John Quinn, Winston-Salem, NC (US)

(21) Appl. No.: 16/437,336

(22) Filed: Jun. 11, 2019

Related U.S. Application Data
(60) Provisional application No. 62/683,416, filed on Jun. 11, 2018.

(51) Int. Cl. G06Q 10/10; G06N 20/00

(52) U.S. Cl. CPC G06Q 10/1057; G06F 16/27; G06N 20/00

(57) ABSTRACT

The described invention connects entities providing healthcare benefits with healthcare service providers without the need for third-party advisers or brokers. This allows self-funding payers to tailor their selections of healthcare services via a direct interface by applying machine-learning and/or blockchain technology to healthcare data acquired in near real-time on patient treatment plans, health insights and patient choice, patient health, and financial insights and control. The described invention further allows the self-funding payer to perform data analytics on the acquired healthcare data to identify savings opportunity and generate a savings recipe for realizing the savings opportunity.

### CROSS-REFERENCE TO RELATED APPLICATIONS

This application claims priority to U.S. Provisional Patent Application No. 62/683,416 filed on Jun. 11, 2018 entitled “SYSTEMS AND METHODS FOR SELECTING HEALTH PLAN BENEFITS,” the entire contents of which is incorporated by reference herein.

### TECHNICAL FIELD

The present invention provides methods and systems for selecting health and/or wellness plan benefits, such as the benefits provided by health insurers. In an embodiment, a method and/or system of the present invention may be advantageously utilized by employers searching for and purchasing healthcare services for their employees. In another embodiment, a method and/or system of the present invention identifies a savings opportunity using data analytics.

### BACKGROUND

With self-funded insurance, an employer (i.e., the payer) pays for their employees' healthcare expenses. As healthcare expenditures rise at an alarming rate in the United States, self-funded employers typically use a bidding process to shop for medical network access, pharmacy benefit management, wellness services, and other services. As such, an adviser or broker for the employer bids on a request for proposal (RFP) when the RFP becomes available. While this enables self-funded employers to obtain the services they provide their employees, this process is often not the most efficient or the most cost-effective means of obtaining healthcare services.

Healthcare costs are continuously rising and are reaching a crisis point. There are a number of root causes that have led to this crisis point. First, pricing is not transparent. Second, one party (i.e., the patient) consumes healthcare services while a different party (i.e., the payer) pays for the healthcare services. Third, basic transactions in the healthcare space are too complex. Fourth, information in the healthcare industry is difficult to measure.

In addition, personal health data has become increasingly fragmented across multiple platforms and/or interfaces. As the personal health data is stored across more and more interfaces, the data is stored using different formats, with different types of data being stored.

All of these factors have come together to create a mess for self-funded employers trying to manage their healthcare spending. The employers generally have no good way of viewing all the relevant information relating to their healthcare expenses and no good way of tracking those healthcare expenses.

Accordingly, there is a need for lower costs and better insights that are tailored to a self-funded employer's business and people, reliable vendors or partners that deliver what they promise, improved health for their people, and a transparent ROI.

### SUMMARY

It is an object of the present invention to provide a marketplace that expands all free-market participants' ability to connect patients and their payers with providers in a transparent and liquid market. The present invention gathers data from multiple external sources and imports that data into a database. As the data is imported, it is cleaned and/or standardized/normalized so that it can be analyzed. After the data has been imported into the database, the data is analyzed using machine-learning algorithms to identify opportunities for savings and/or healthcare optimization from the employer's perspective. The identified opportunities for savings and/or healthcare optimization are provided to the employer as claim facts and/or recipes, each of which provide actionable data that can be used to achieve savings. The present invention provides projected savings numbers to the employer and can track the employer's actual savings against the projected savings.

According to an embodiment of the present invention, a method of clearing electronic transactions through a network for a self-funded payer is disclosed. The method includes acquiring healthcare data from a data source. The healthcare data is acquired using a data intake utility by connecting the data intake utility to the data source over the network. The method further includes preparing the acquired healthcare data. Preparing the acquired healthcare data includes cleaning the acquired healthcare data. The method further includes analyzing the acquired healthcare data to identify an insight based on the acquired healthcare data. The method further includes organizing insights based on the acquired healthcare data. The method further includes formulating a data model based on the insights.

In one embodiment, the method of clearing electronic transactions through a network for a self-funded payer further comprises applying blockchain technology to the formulated data model.

In one embodiment of the method of clearing electronic transactions through a network for a self-funded payer, cleaning the acquired healthcare data includes transforming at least some of the acquired healthcare data into a format that is different from the format in which the healthcare data was acquired.

In one embodiment of the method of clearing electronic transactions through a network for a self-funded payer, the different format is a standardized format.

In one embodiment of the method of clearing electronic transactions through a network for a self-funded payer, the organizing insights is performed using machine learning to identify trends in the acquired healthcare data.

In one embodiment of the method of clearing electronic transactions through a network for a self-funded payer, the data model identifies a savings opportunity based on the organized insights and the opportunity is quantified into a numerical value based on the acquired healthcare data and the data model.

According to another embodiment of the present invention, a method of identifying a savings opportunity in healthcare data for a self-funded payer is disclosed. The method includes receiving, via a data intake utility, healthcare data from an external data source. The healthcare data includes patient health data. The healthcare data is received over a network connection that connects the data intake utility to the external data source. The method further includes storing the received healthcare data in a database. The method further includes performing data analytics on the received healthcare data. The data analytics includes a benefits analysis to determine projected benefits. The data analytics further includes a spending analysis to determine projected spending. The data analytics further includes a savings analysis to determine projected savings. The method further includes determining a claim fact based on the data analytics performed on the received healthcare data. The method further includes generating a savings recipe for realizing a savings opportunity based on the determined claim fact.

In one embodiment of the method of identifying a savings opportunity in healthcare data for a self-funded payer, determining the claim fact includes checking for claim accuracy of a received medical claim.

In one embodiment of the method of identifying a savings opportunity in healthcare data for a self-funded payer, determining the claim fact includes checking for contract compliance of a received medical claim.

In one embodiment of the method of identifying a savings opportunity in healthcare data for a self-funded payer, the received healthcare data is cleaned as part of storing the received healthcare data in the database.

In one embodiment of the method of identifying a savings opportunity in healthcare data for a self-funded payer, the data analytics is performed using machine learning to identify trends in the received healthcare data.

In one embodiment of the method of identifying a savings opportunity in healthcare data for a self-funded payer, the data analytics includes performing claim reconciliation on a received medical claim.

In one embodiment of the method of identifying a savings opportunity in healthcare data for a self-funded payer, the database includes a plan library that comprises a benefits plan, a savings plan, and a spending plan.

According to another embodiment of the present invention, a system for identifying a savings opportunity in healthcare data is disclosed. The system includes an interface layer. The interface layer includes a data intake utility configured to connect to an external data source. The system further includes a database. The system further includes a data analytics server. The server comprises a processor. The processor is configured for receiving, via the data intake utility, healthcare data from the external data source. The healthcare data includes patient health data. The healthcare data is received over a network connection that connects the data intake utility to the external data source. The processor is further configured for storing the received healthcare data in the database. The processor is further configured for performing data analytics on the received healthcare data. The data analytics includes a benefits analysis to determine projected benefits. The data analytics further includes a spending analysis to determine projected spending. The data analytics further includes a savings analysis to determine projected savings. The processor is further configured for determining a claim fact based on the data analytics performed on the received healthcare data. The processor is further configured for generating a savings recipe for realizing a savings opportunity based on the determined claim fact.

In one embodiment of the system for identifying a savings opportunity in healthcare data, determining the claim fact includes checking for claim accuracy of a received medical claim.

In one embodiment of the system for identifying a savings opportunity in healthcare data, determining the claim fact includes checking for contract compliance of a received medical claim.

In one embodiment of the system for identifying a savings opportunity in healthcare data, the received healthcare data is cleaned as part of storing the received healthcare data in the database.

In one embodiment of the system for identifying a savings opportunity in healthcare data, the data analytics is performed using machine learning to identify trends in the received healthcare data.

In one embodiment of the system for identifying a savings opportunity in healthcare data, the data analytics includes performing claim reconciliation on a received medical claim.

In one embodiment of the system for identifying a savings opportunity in healthcare data, the database includes a plan library that comprises a benefits plan, a savings plan, and a spending plan.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The present embodiments are illustrated by way of example and are not intended to be limited by the figures of the accompanying drawings. In the drawings:

FIG. 1A illustrates a traditional relationship between an employer, its employees, a broker, and a health services provider.

FIG. 1B illustrates a new relationship between employers, health services providers, and employees as provided by an exemplary embodiment of the electronic clearing network for healthcare payers described herein.

FIG. 2 illustrates an exemplary process of matching services to needs without a third-party broker, as described herein.

FIG. 3 depicts sources of incoming data that are used for the electronic clearing network for healthcare payers.

FIG. 4 depicts an exemplary embodiment of a method for enhanced decision-making using the data analytics framework for identifying a savings opportunity for self-funded healthcare payers described herein.

FIG. 5 shows an exemplary embodiment of the data analytics framework for identifying a savings opportunity for self-funded healthcare payers described herein.

FIG. 6 depicts an exemplary embodiment of the data analytics framework for identifying a savings opportunity for self-funded healthcare payers.

FIG. 7 depicts a hierarchical organizational structure for plan libraries used in an exemplary embodiment of the data analytics framework for identifying a savings opportunity for self-funded healthcare payers.

FIG. 8 depicts a hierarchical organizational structure for benefits plan used in an exemplary embodiment of the data analytics framework for identifying a savings opportunity for self-funded healthcare payers.

FIG. 9 depicts a hierarchical organizational structure for savings plan used in an exemplary embodiment of the data analytics framework for identifying a savings opportunity for self-funded healthcare payers.

FIG. 10 depicts a hierarchical organizational structure for financial controls used in an exemplary embodiment of the data analytics framework for identifying a savings opportunity for self-funded healthcare payers.

FIG. 11 depicts a hierarchical organizational structure for spending plan used in an exemplary embodiment of the data analytics framework for identifying a savings opportunity for self-funded healthcare payers.

FIG. 12 depicts an exemplary structure of the data analytics framework for identifying a savings opportunity for self-funded healthcare payers.

### DETAILED DESCRIPTION

The present invention provides a data analytics framework for identifying a savings opportunity for self-funded healthcare payers, such as self-funded employers. In the context of the present invention, healthcare comprises the maintenance and/or improvement of an individual's physical and/or mental health through the provision of services, including medical and/or wellness services. The health care spectrum includes various aspects: (1) finance and administration; (2) preventative care; and (3) curative care.

The data analytics framework for identifying a savings opportunity for healthcare payers described herein connects medical claims, pharmacy claims, biometrics, demographics, and health conditions to create a detailed view of an individual's health-care spending and a simplistic view of their health condition. It provides broader access to high-quality data, continuous analytics, and near-real-time outcome-tracking to deliver an improved payer experience.

By building a unified view of a person's health care, the data analytics framework described herein is able to apply analytics to the data to create insights about the population being served. The insights created about the population being served may be translated into actionable data that can create a measurable financial benefit for the payer.

As explained above, fragmented healthcare data across multiple interfaces is “dirty.” Although the fragmented data may include standard fields (e.g., procedure performed, units of service provided, diagnosis at check-in, service and dates, amount paid, provider involved, etc.), the data contained in those standard fields may not be formatted in the same way. In addition, the fragmented data across multiple interfaces may include non-standard fields, which means that it is difficult to know what data should be expected from each incoming data source. The data analytics framework for identifying a savings opportunity for healthcare payers described herein provides methods and systems for integrating the fragmented data, cleaning that data, and standardizing that data such that it can be analyzed and/or used in a consistent way.

The data analytics framework for identifying a savings opportunity for healthcare payers described herein builds a unified person identity across data sets. It allows claim reconciliation, such as reconciling claims paid with their eligibility, reconciling claims with payments, and monitoring claim payments against vendor contracts.

By cleaning the fragmented data, the data analytics framework for identifying a savings opportunity for healthcare payers allows for translation from vendor-specific code values to external standardized values.

The data analytics framework for identifying a savings opportunity for healthcare payers is configured to intake data from a variety of vendors using data intake utilities. The data intake utilities may be customized for each external vendor to which they are interfacing, or they may be standardized utilities that can handle many known external vendors. The data intake utilities connect to outside data sources (e.g., the vendors) over a network connection and access the data stored at the outside data sources. Cleaning the intake data involves standardizing non-standard values and fixing any errors using intelligent text-processing. The text-processing may be performed on the incoming data and/or on the fields where the incoming data is coming from is stored to determine a best guess for what the piece of intake data represents. This may be done using pattern matching, type matching, text matching, format matching, flags, historical data, and/or manual training and verification, etc. The intelligent text-processing may include using machine-learning algorithms to build more robust data sets from the intake data. That is, as the system processes more incoming data, it learns what fields represent what types of information for a particular data source as well as across multiple data sources.

The data analytics framework for identifying a savings opportunity for healthcare payers combines the intake data across data sources using machine-learning powered recommendations. The intake data may be further enriched and classified using semantic and/or syntactic understanding of the data to identify breaks in consistency, likely groupings in the data, and variation in the data that can be eliminated.

The data analytics framework for identifying a savings opportunity for healthcare payers is configured to organize insights and strategies, which allows for identification and sizing of improvement options that may either reduce cost, improve care coordination, or both. The improvement options may be used to create financial improvements for the payer. In addition, the data analytics framework for identifying a savings opportunity for healthcare payers is configured to track improvement progress over time. For example, the system may determine the insight that the payer is paying $X for a particular drug filled with Pharmacy A and $2X for that same drug filled at Pharmacy B. The system may identify, based on this insight, the savings opportunity for saving $X multiplied by the number of times that prescription is filled at Pharmacy B if everybody who currently fills that prescription at Pharmacy B were to switch to filling that prescription at Pharmacy A. The system may further identify an additional savings opportunity based on shifting all the Pharmacy B purchasers to Pharmacy A, which would qualify the payer for additional volume discounts with Pharmacy A, resulting in further savings. Similarly, the system may further identify an additional savings opportunity based on switching all purchasers from the particular drug to a generic version of that drug.

The improvement options may include network management (i.e., savings driven by proactive management of out-of-network, outpatient, inpatient, and laboratory service events), pharmacy management (i.e., proactive monitoring of pricing errors, ineffective prescriptions, alternate purchase of delivery channels, and rebates), provider management (i.e., active build-up of narrow network combined with case management to route employees to improved care and value), claims accuracy (i.e., savings driven by proactive, pre-payment identification and dispute of claim errors, such as duplicate claims, incomplete claims, and/or unneeded claims), case management (i.e., savings driven by improved focus on cases of value, and Return on Investment with vendor(s) delivering case, and disease management), population health (i.e., improved incentive design, and employee interaction to improve employee health), and/or vendor management (i.e., improved coordination and rationalization of services resulting in decreased cost, and improved service/care).

Improvement options relating to network management include savings provided by proactive management of out-of-network, outpatient, inpatient, and laboratory services. Improvement options relating to pharmacy management include monitoring of pricing errors (e.g., the same drug from the same pharmacy being billed at a higher price for some users and a lower price for other users), ineffective prescriptions (e.g., prescriptions being used for longer than normally required with repeat visits to the doctor for the same condition), alternate purchase or delivery channels (e.g., switching providers and/or switching to generics), and/or rebates (e.g., tracking available rebates and/or the status of those rebates against claims).

Improvement options relating to provider management include building a network and providing case management to route employees to improved care and value.

Improvement options relating to claims accuracy include savings from identifying pre-payment options and savings from identifying claim errors, such as duplicate claims, incomplete claim, and/or unneeded claims. Improvement options relating to case management include savings from identifying the most valuable cases with the highest ROI across various vendors.

Improvement options relating to population health include improved incentive design and employee interaction to improve employee health. Improvement options relating to vendor management include better coordination and rationalization of services, which results in decreased cost and/or improved care.

The data analytics framework for identifying a savings opportunity for healthcare payers includes complete medical claim, complete pharmacy claims, biometrics, new demographics (e.g., social determinants), and actionable health scoring. It integrates and analyzes this data to deliver a continuous data-driven decision-making process. This allows the data analytics framework to generate comprehensive financial and population health insights, as well as improve financial controls.

The data analytics framework for identifying a savings opportunity for healthcare payers links insights, actions, and outcomes, which are all necessary for continuous improvement. It delivers ever-green data, continuous analytics, and ongoing detection to help employers meet their cost saving and health improvement goals.

The data analytics framework described herein may use a graphical user interface (“GUI”) on the front-end that is serviced on the back-end by machine-learning and implemented using blockchain technology. Machine-learning provides the ability to manage the complexity of the incoming and stored data sets and to scale the data analytics framework as more vendors are added and more healthcare payers are added.

The data analytics framework described herein may use data available in real-time or near real-time to optimize patient treatment plans, health insights and patient choice, patient health, and financial insights and control.

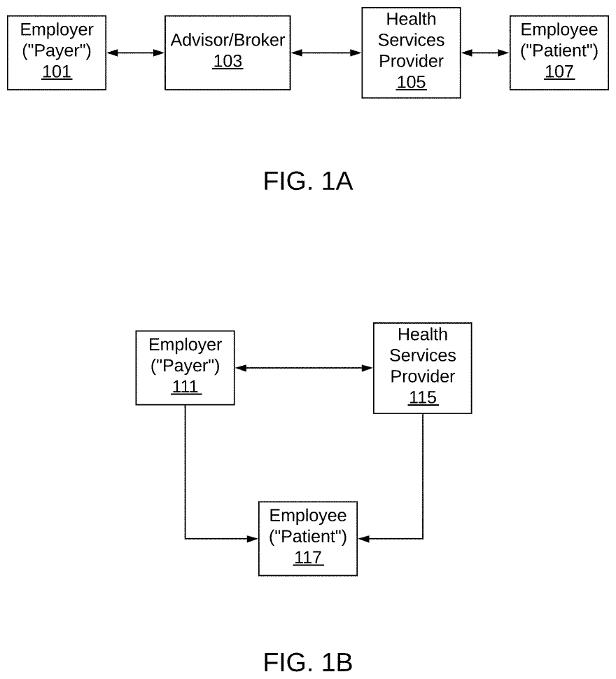

FIG. 1A illustrates a traditional relationship between an employer, its employees, a broker, and a health services provider. As shown in FIG. 1A, such relationship often includes one or more third parties that mediate transactions, such as advisor/broker 103, between the employer (“payer”) 101 and health services provider 105, which provides health services to the employee (“patient”) 107.

FIG. 1B illustrates a new relationship between employers, health services providers, and employees as provided by an exemplary embodiment of the electronic clearing network for healthcare payers described herein. As shown in FIG. 1B, an embodiment of the present invention removes the need for the third parties that mediate transactions between employers and healthcare service providers. To accomplish this, an embodiment of the present invention provides an interface that is accessible to employers, who often have little or no training in data analytics or health management. This employer-accessible interface enables direct connection between employers/payers 111, employees/patients 117, and healthcare providers 115, absent any third-party adviser or broker.

Embodiments of the present invention may advantageously expand all free market participants' ability to connect patients and their payers with providers in a transparent and liquid market. In an embodiment, the present invention connects market participants using blockchain as a means of exposing and sharing data across enterprise boundaries, promoting a more efficient healthcare marketplace.

Embodiments of the present invention may allow consumers (employers and employees) to connect or uncover needs, product quality, and price to support allowing consumers to make smarter decisions. Although many organizations are working on need, product quality, and price in the form of web, or mobile apps, many of those organizations are contributing to a growing problem of personal health data fragmented across customer interface options (described above). Rather than adding to the web of consumer interface options, an object of an embodiment of the present invention is to create data utilities that can be accessed, for example via blockchain, to support consumer expertise or the substantial list of care delivery players. An embodiment of the present invention may provide employers and their staff with detailed information, enabling them to take action on smaller populations and achieve steadier progress to an improved outcome. An embodiment of the present invention provides the data platform that enables benefit managers to carry out benefit management adhering to typical process improvement methods (such as SixSigma). SixSigma includes five steps: define the scope of the problem, measure and characterize the outcomes, analyze and reconfigure the solution, improve and implement the next iteration, and control and sustain success.

The inventor of the present invention identified a problem including prices lacking transparency, one party (the patient) consuming and a different party (the payer) paying, overly complex basic transactions, and unpredictable success and failure. A solution to this problem is provided by an embodiment of the present invention that in part begins with a strategy: capture, clean, and connect data (e.g., price, employee health, and care utilization); identify purchase strategies (or care strategies) that work; measure the strategies deployed; and revise and improve continuously.

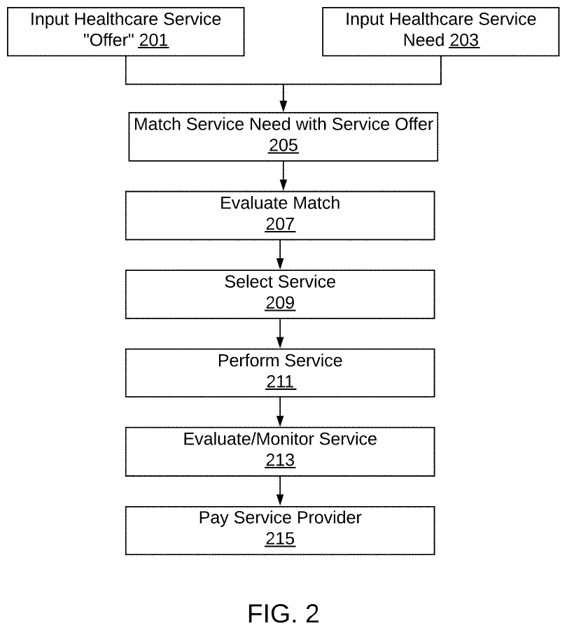

FIG. 2 illustrates an exemplary process of matching services to needs without a third-party broker, as described herein.

Referring to FIG. 2, healthcare service providers offer healthcare services, and employers have healthcare service needs. At step 203, an employer provides input of the healthcare service they need to purchase. The inputs may comprise one or more of the following: (1) current list of vendors (referred to as vendor stack), along with contract terms and pricing; (2) two or more years of historical medical claims, pharmacy claims, and biometrics tied to their employees; (3) current health plan details and financials; (4) management objectives or current case strategies that need to be achieved. This user input may be provided via an interface. In one embodiment, the inputs support a healthcare data exchange format.

At step 201, a healthcare service “offer” is input. The healthcare service offer may be an offer from any healthcare service provider, such as, for example a pharmacy, a hospital, a laboratory provider, etc. At step 205, the healthcare service offer is matched with the employer's need. The match is evaluated at step 207 and selected at step 209. In one embodiment, the matching, evaluation, and selection may be performed using data analytics, machine-learning, and/or blockchain technology. This matching, evaluation, and selection process is completed following transmission of the input data over one or more networks to a server, which contacts data stored in a database. The processing infrastructure is a cloud, such as the Amazon Web Services (AWS) cloud. The database may be a cloud-based database, such as the AWS Relational Database Service (RDS). Other information may be stored in a cloud-based storage service, such as the AWS Simple Storage Service (S3). The software catalog and library may be Symantec. In an embodiment, a method of the present invention may run on a private cloud-computing platform using object-oriented and/or functional programming languages using a combination of rational and non-rational data storage solutions.

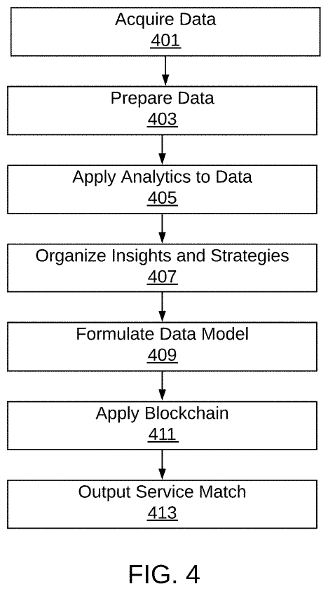

In an embodiment, the backend of this interface is serviced via the process presented in FIG. 4 (explained in more detail below).

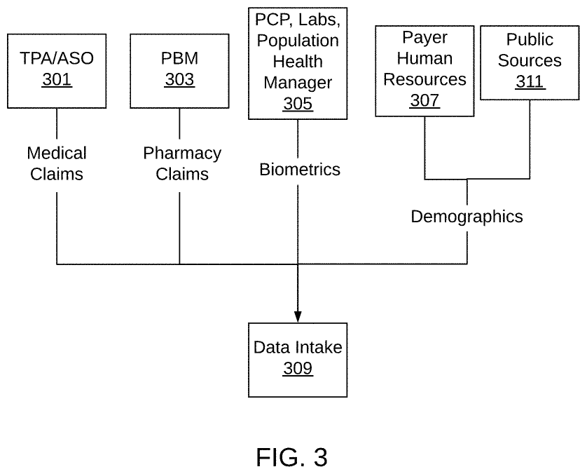

FIG. 3 depicts sources of incoming data that are used for the electronic clearing network for healthcare payers. As shown in FIG. 3, the sources of incoming data may include, for example, medical claims from third-party administrators (“TPA”) and/or Administrative Services Only (“ASO”) providers 301. The sources of incoming data may further include pharmacy claims from Pharmacy Benefits Manager (“PBM”) 303. The sources of incoming data may further include biometric data from sources such as a primary-care physicians (“PCP”), laboratories, and/or population health managers 305. The sources of incoming data may further include demographic information from sources such as the employee/payer's human resources records 307 as well as public sources 311. The incoming data collected by the system described herein are input to data intake 309.

FIG. 4 depicts an exemplary embodiment of a method for enhanced decision-making using the data analytics framework for identifying a savings opportunity for self-funded healthcare payers described herein. The method comprises one or more of the following steps: acquiring health data for a population to receive healthcare services (step 401); preparing the acquired data (step 403); applying analytical tools to the acquired data to develop insights about and/or a unified health view of the population being served (step 405); organizing insights and strategies via data analytics tools (step 407); formulating a data model (step 409); and outputting a service match (step 411).

At step 401, the data analytics framework for identifying a savings opportunity for healthcare payers acquires health data for a population to receive healthcare services. The population to receive healthcare services may be, for example, the employees of a company that is a self-pay healthcare provider. The data may be acquired, in part, for example, from the employer's third-party administrator(s) and the employer's data. The data may include, for example, biometrics, demographics, health conditions, medical claims, and pharmacy claims of one or more of the employees of the employer. This data may be combined to form a unified health view of one or more of the employees, which is a detailed view of an individual's healthcare spending and simplified view of the individual's health condition. The detailed view may include a complete claim record, including a patient's personally identifiable information (“PII”). The simplified view may not include a patient's PII. Both the detailed view and the simplified view may be developed by connecting biometrics, demographics, health conditions, medical claims, and pharmacy claims.

At step 403, the data analytics framework for identifying a savings opportunity for healthcare payers prepares the acquired data. As part of preparing the acquired data, the acquired data may be cleansed. As explained above, the incoming acquired data comes from multiple disparate data sources, and the data may be fragmented and/or “dirty.” Cleansing the data may include formatting the data, adding missing data, and/or removing unnecessary or bad data. The acquired data may be prepared to provide for integration, quality, and/or enrichment of the data. Preparing the acquired data may include one or more of the following: (1) integrating the unified identity of a person across data sets; (2) reconciling eligibility with claims paid; (3) reconciling claims with payments; (4) associating medical claim provider data with provider identity; (5) associating prescription claim with drug identity and/or pharmacy identity; (6) performing diagnostic/procedure code crosswalks and/or clean-up; (7) monitoring claim payments against vendor contracts; (8) translating vendor-specific code values to external standards; (9) episode of care across individual claims; (10) early detection on Incurred But Not Received (IBNR) claims; (11) association of people with disease groups; (12) associating medical procedures with Medicare reference pricing; and/or (13) connecting to and/or accessing internal and external analytic engines.

At step 405, the data analytics framework for identifying a savings opportunity for healthcare payers applies analytical tools to the acquired data. The analytical tools may be used to develop insights about the population being served. The analytical tools may further be used to develop a unified health view of the population being served.

At step 407, the data analytics framework for identifying a savings opportunity for healthcare payers organizes insights and strategies (step 407) via data analytics tools. The insights and strategies provided by the data analytics tools are organized to support end-users who are not trained as data analytic experts. The organization of insights and strategies may include one of more of the following: (1) version management of claim records across external analytic partners; (2) version management of claims and cases made accessible to wellness (or other care management) groups; (3) managing access to Protected Health Information (“PHI”); and/or (4) managing access to Personally Identifiable Information (“PII”) access management.

The data analytic tools used to organize insights and strategies in step 407 may include tools to perform one or more of the following: (1) intake of data in various formats from various vendors; (2) search, exploration, and discovery of data sources and data values in real-time for identification of trends, outliers, and data quality issues; (3) cleaning of data via standardization of values and remediation of errors using text-processing tools; (4) combination of data across data sources with recommendations provided via machine learning; (5) enrichment and classification of data via semantic and syntactic assessments of the data for likely groupings, eliminable variation, and connection to enrichment sources using fuzzy logic; and/or (6) collaboration, sharing, and reuse of data across external vendors.

At step 409, the data analytics framework for identifying a savings opportunity for healthcare payers formulates a data model. The formulated data model may include one or more of: (1) a unified view of a person in the population's healthcare; (2) identification and sizing of improvement options; (3) attribution of financial improvements to individual savings initiatives; and/or (4) implementing blockchain to expose and share data across enterprise boundaries in the healthcare marketplace.

The identification and sizing of improvement options may provide for a reduction in cost and/or an improvement in care coordination. The identification and sizing of improvement options may be performed using internal analytic models and/or external analytic vendors. The internal analytical models may comprise one or more of the following taxonomies: network management; pharmacy management; provider management; claims accuracy; case management; population health; and vendor management. The internal analytical models may be applied individually or combined with one another to identify improvement options for reducing costs or improving care coordination. The external analytic vendors that expand the scope of opportunities available to an employer or health plan may include, for example, Medicare Reference Based Pricing, Tesser Health Analytics, WhiteHat AI, J.Graham Inc., Orthus Health, Bravo, and Know Your Number (KYN). This list of external vendors may expand and/or change according to client needs and availability of new vendors with superior analytics.

The attribution of financial improvements may comprise an improvement in transparency on Return on Investment (“ROI”).

At step 411 (optional), the data analytics framework for identifying a savings opportunity for healthcare payers optionally applies blockchain technology to expose and share data across enterprise boundaries in the healthcare marketplace. The implementation of blockchain may provide a digital direct-to-employer interface and/or allow for leveraging of data standards. The interface may enable a direct connection between a selector of healthcare services and a provider of healthcare services. The interface may comprise a non-Accountable Care Organization (ACO) model; or an ACO model.

A non-ACO model may comprise one or more of the following: (1) healthcare services pricing; (2) digital contracting (Smart Contracts) at the employee fee-for-service level; (3) an electronic medical record (EMR) interface; (4) provider-supported patient care modules (e.g., WhiteLabeled MyChart from Epic); (5) an eligibility interface; (6) an employee benefit support interface (customer service for employees); (7) an employee healthcare navigation interface (health concierge for employees); (8) an employee personal health record interface; (9) a payments interface; and/or (10) a health and wellness coordination platform.

An ACO model may comprise one or more of the following: (1) employee level historical healthcare utilization; (2) employee level current-state health condition; (3) employee ACO pricing tiers; and/or (4) elements from the Non-ACO model.

Where possible, the blockchain implementation may leverage data standards. For example, a standard applied for medical claims is the ANSI ASC X12N 837 standard. The standard applied for pharmacy claims is the NCPDP vD.0 standard. The standards applied for personal health records include WebMD Health Manager, Apple's PHR for iPhone, and PHR's using HL₇ FHIR standard. The standard applied for electronic health records is HER's using HL₇ FHIR standard. The standard applied for biometrics is the HL₇ FHIR standard. The standard applied for health risk assessments is the HL7 FHIR standard. The standard applied for activity tracking is Validic.

At step 413, a resulting output is provided that provides a service matched with the input the employer provides regarding its needs. The selected service reflects the service that is determined to be the most suitable to the employer based on the data acquired, assessed, and applied in the previous steps.

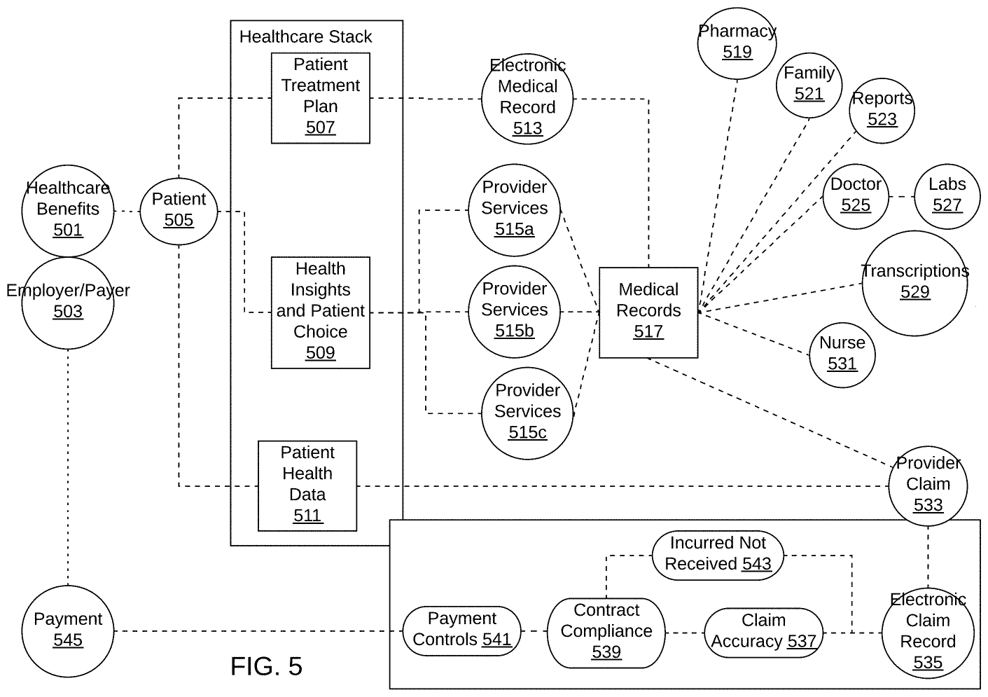

FIG. 5 shows an exemplary embodiment of the data analytics framework for identifying a savings opportunity for self-funded healthcare payers described herein.

Referring to FIG. 5, the system described herein includes a healthcare stack for a patient, which comprises a patient treatment plan 507, health insights and patient choice 509, and patient health data 511. A self-funded employer's employees are patients. The healthcare stack receives patient data 505. The patient data 505 includes healthcare benefits 501 and employer/payer information 503. The patient data 505 is used for the patient treatment plan 505, the health insights and patient choice 509, and the patient health data 511. The patient's data that makes up the healthcare stack is used to provide the patient with one or more provider services 515a, 515b, and/or 515c. As the provider services 515a, 515b, and/or 515c are provided to the patient, the patient's medical records 517 are updated accordingly. For example, when a patient visits the doctor, the doctor may update the patient's medical records to reflect the diagnosis from that visit. The update from the doctor may include diagnostic codes, prescription information, health and wellness information, etc. Other information is provided to the patient's medical records, for example, pharmacy data 519, family data 521, report data 523, doctor information 525, lab information 527, transcriptions 529, nurse information 531. For example, if the patient has blood work performed during the visit with the doctor, the patient's medical records are updated to include the results of the bloodwork.

From a patient's medical records 517, a provider claim 533 may be generated. For example, when a patient goes to the doctor, the doctor may create a claim so that they can get paid for their services. The provider claim 533 may generate an electronic claim record 535. The electronic claim record 535 may be imported into the system for analysis. The electronic claim record 535 may be checked for claim accuracy 537. In some cases, after an electronic claim record 535 is generated but the claim has not yet been received, the claim is considered incurred but not received 543. The electronic claim record 535 may be checked for contract compliance 539. The electronic claim record 535 may be compared to payment controls 541.

The employer/payer 503 may submit payment 545 for the services, which may be submitted through payment controls 541. When the payment 545 is submitted, the system records this information for analysis.

The example shown in FIG. 5 shows information for one patient/employee. The system described includes the same or similar data for each patient/employee. Thus, each patient/employee has their own healthcare stack, their own service providers, and their own claims information. As described in more detail, the system described herein includes a holistic view of all this data across all the patient/employees.

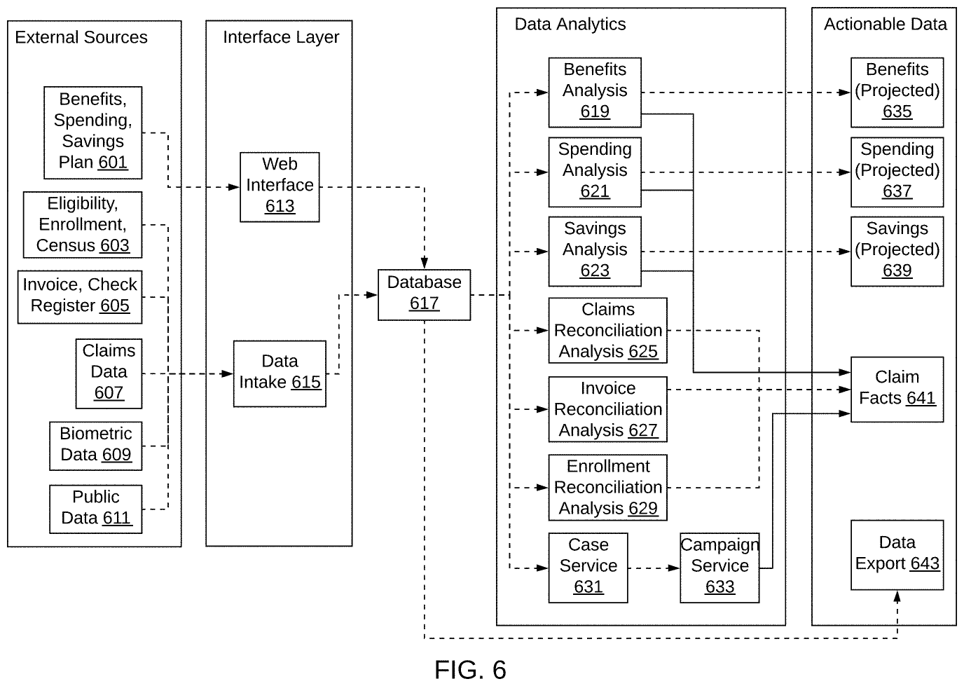

FIG. 6 depicts an exemplary embodiment of the data analytics framework for identifying a savings opportunity for self-funded healthcare payers.

The system described herein comprises a back-end data analytics system that takes input from various external sources through an interface layer, stores that information in a database, and performs analytics on the input data to create actionable data that an employer/payer can use to identify problems and/or opportunities for savings in their healthcare costs and address those problems/opportunities. Information from exemplary external sources may include information relating to an employee's benefits, spending, and savings plan 601; an employee's eligibility, enrollment, and census information 603; invoice and/or check register information 605; and/or claims data 607. The external sources may further include biometric data 609. The external sources may further include public data 611. The exemplary external sources shown in FIG. 6 may be accessed electronically using any known standards, such as by using blockchain, by using APIs, or by using other types of external integration.

The information from the external sources are input to the system through an interface layer. The interface layer may include a web interface 613 and/or one or more data intake utilities 615. The web interface 613 may be a web-based interface accessible through an internet browser, or it may be accessible through a software application (e.g., mobile app, desktop app, etc.). The data intake utilities 615 may include customized connectors used for connecting the back-end system to various external sources, based on the type and format of the data being brought into the system through the data intake system 615.

The system communicates over one or more networks. The system may be accessible by any commercially available device, such as, for example, cellular phones (e.g., Apple iPhone, Android devices) and network-enabled devices (e.g., desktop computer, laptop computer, tablets, netbooks, 2-in-1 computers, etc.). The devices may communicate over a wired network connection, a wireless connection (e.g., 802.11 WiFi, Bluetooth, etc.), and/or a cellular connection.

The database 617 may be any type of known database. For example, in one embodiment, the database 617 may be an Amazon AWS RDS. In one embodiment, the database 617 is a SQL database. Other known database technologies may be used. As part of the data intake 615, the incoming data from the external sources may be cleaned and/or formatted such that it can be understood and used by the database, as explained in the context of FIG. 4.

As explained in the context of FIG. 4, the data intake utilities 615 may perform cleaning and/or standardization of the incoming data so that it is stored in the database 617 in a known and understood way. In some embodiments, the raw incoming data is stored in database 617 before making a copy of the raw data for cleaning. This allows for the system to always have a copy of the “original” data that can be used for other purposes.

The database 617 may store information related to clients, which are self-funded payers, in one or more linked data tables. For example, the database 617 may include a client data table, a client plan data table, a client plan item data table, a plan library type data table, a plan library data table, a plan library modality data table, a plan item node data table, a plan item node type data table, an import process data table, a job import data table, a claim data table, a client data table, a claim fact data table, a claim fact detail data table, and an analytic partner data table. Each of the data tables in database 617 may include information about a client, a plan, and/or a claim. The data tables are linked to one another using keys within the data (e.g., as in a relational database).

For example, the database 617 may store a client identification (client_id) for each client as well as other information about the client, such as client name, client employer identification number (“EIN”), contact information for the client, a number of employees of the client, a number of years of existence of the client, archives of the client information, a payroll schedule for the client, a payroll service of the client, and other items relating to the client. The client_id may be used as a key in the database to link to other tables in the database, such as a client plan data table.

The client plan data table may include information about the client plan, such as a client plan identification, a year of the client plan, a description of the client plan, a plan library type identification, and other items relating to the client plan. The client plan identification may be used as a key in the database to link to a client plan item data table. The plan library type identification may be used as a key in the database to link to other tables in the database, such as a plan library type data table.

The client plan item data table may include a client plan item identification, a client identification, a client plan identification, a client plan item projected value, a client plan value, and other items relating to the client plan item.

The plan library type data table may include a plan library type identification, plan library type name, plan library type description, and other items relating to the plan library type.

The plan library data table may include a plan library identification, plan library parent identification, plan library hierarchy path, plan library description, plan library style, plan library modality identification, plan library type identification, plan item node type identification, and other items relating to the plan library.

The plan library modality data table may include a plan library modality identification, a plan library modality name, a plan library modality type, a plan library modality control, plan library modality attributes, a plan library modality style, and other items relating to a plan library modality.

The plan item node data table may include a plan item node identification, a plan library identification, a plan item node type identification, and other items relating to a plan item node.

The plan item node type data table may include a plan item node type identification, a plan item node data type, a plan item node type description, plan item not type case columns, and other items relating to a plan item node type.

The import process data table may include an import process identification, an import process description, an import process status, an import process type, an import process file transform process, a client identification, a data provider identification, and other items relating to an import process. The information in the import process data table may be used by a data intake utility for connecting to an external data source and importing data from the external data source. For example, the import process information may specify the format of incoming data from a particular external data source.

The job import data table may include a job import identification, a job import type, a job import status, a client identification, a data provider identification, an import process identification, and other items relating to a job import. The information in the job import data table may be used by the data intake utility for tracking process of the data import from an external data source.

The claim data table may include a claim identification, subscriber information for the claim, a client identification, an external claim identification, an external claim line number, a claim version number, a status of the claim, an external status of the claim, a type code of the claim, a claim subtype code, a claim plan type code, a claim revenue code, dates relating to the claims (e.g., service start date, service end date, admission date, discharge date), a claim paid date, a claim received date, a claim adjudication date, a claim adjudication comment, a claim set purpose code, a claim type of service, a claim frequency type code, a claim bill type, a claim original reference identification, a claim submitter identification, a claim submitter name, a claim receiver identification, a claim receiver name, a claim payor identification, a claim payor name, claim charges billed, claim charges ineligible, claim charges allowed, claim charges savings, claim charges copay, claim charges deductible, claim charges paid by patient, claim charges payment details, claim charges payor discount, and other items relating to a claim.

The claim fact data table may include a claim fact identification, a client identification, a claim fact plan year, a plan library identification, an analytic partner identification, a claim fact external issue code, a claim fact external issue description, a claim fact external issue projected savings, and other items relating to a claim fact.

The claim fact detail data table may include a claim fact detail identification, a claim fact identification, and other items relating to details of a claim fact.

As explained above, the data tables listed above may be linked to one another within the database 617 using one or more primary keys and/or foreign keys. The data tables may be linked in a one-to-one, one-to-many, and/or a many-to-many relationship. When a data intake utility is used to import data from an external source, and after the data intake utility has cleaned the imported data, the imported data is stored in the database 617 in one or more of these data tables. A new data table may be created for each piece of information, for example, a data table may be created in database 617 for each imported claim. For each claim, a claim fact data table may be created based on the information of the claim.

The data analytics in the back-end system include multiple data analytics tools that analyze the cleaned data to identify areas for optimization in an employer's healthcare costs. The data analytics may include a benefits analysis 619. The benefits analysis 619 may analyze an employer's overall benefits plans to identify potential areas for savings. For example, the benefits analysis 619 may determine that the benefits plan being used by a particular employer is most beneficial to employees who visit the doctor frequently for non-preventative issues generally associated with older people whereas the employer's actual employees generally are younger, rarely visit the doctor, and generally only visit the doctor for preventative-type issues. In such a situation, the benefits analysis 619 may determine that the employer has not selected the optimal benefits plan for their employees. The data analytics may include a spending analysis 621. The spending analysis 621 may analyze an employer's overall spending to forecast future spending and/or identify potential areas for savings. For example, the spending analysis 621 may determine areas where the employer is spending a disproportionate amount of money, such as a particular provider being substantially more expensive for the same service, etc. The data analytics may include a savings analysis 623. The savings analysis 623 may track and/or analyze savings incurred as a result of the system. For example, the savings analysis 623 may monitor recommendations provided (described below) and quantify the amount of money saved as a result of the changes made. The data analytics may include a claims reconciliation analysis 625. The claims reconciliation analysis 625 intelligently reconciles claims to identify potential problems such as duplicate claims, claims that have already been paid, etc. The data analytics may include an invoice reconciliation analysis 627. The invoice reconciliation analysis 627 intelligently reconciles claims with invoices to identify potential problems such as duplicate entries on an invoice, duplicate invoices from different providers, invoices that have already been paid outside of a claim, etc. The data analytics may include an enrollment reconciliation analysis 629. The enrollment reconciliation 629 intelligently reconciles claims with enrollment information determine whether claims are proper and/or whether a patient/employee is properly enrolled in the employer's benefits plan.

In addition, the data analytics may include a case service 631 and a campaign service 633. The case service 631 and campaign service 633 are used for identifying opportunities for employer savings. As explained, the system described herein determines one or more opportunities for savings for healthcare provided by self-funded employers. The identified opportunities may apply at different levels within the system. For example, savings opportunities may be identified for a particular employee (e.g., employee X), a group of employees (e.g., all male employees under 40 years old, all employees who wear contacts, all employees with a BMI above 30, etc.), a particular service provider (e.g., hospital system X), or all employees. When opportunities are grouped, they may be considered as cases and/or campaigns. An individual opportunity or group of related opportunities may be considered a case. For example, any claim that is a duplicate claim may be a duplicate-claim case. Cases may be identified by the system through machine learning, or they may be manually identified by a user of the system. For example, a user of the system may query the database for all claims above 1,000 that occurred during the month of May and assign the resulting claims to a particular case. A strategic approach for solving issues identified may be considered a campaign. For example, a campaign may include all the duplicate-claim cases to eliminate the extra spend associated with the duplicate claims. Another example of a campaign may be an employee fitness campaign, where the employer provides exercise resources and offers fitness classes to the employees. The case service 631 tracks and manages cases, and the campaign service 633 tracks and manages campaigns.

Information created by the data analytics back-end system is converted into actionable data by the back-end system. The benefits analysis 619 determines projected benefits 635. This may occur based on the benefits analysis 619 by looking at historical trends of benefits and future-looking benefits information, taking into account projected changes to benefits plans. The spending analysis 621 determines projected spending 637. The projected spending 637 may be determined based on historical trends and future-looking information. The savings analysis 623 determines projected savings 639. The projected savings 639 may be determined based on historical trends and future-looking information. The projected savings 639 may take into account the recommended cases and/or campaigns and other actionable intelligence to provide potential savings that may be incurred. For example, the system may determine that the employer will save 100,000 by catching all duplicate claims. The system may further determine that the employer will save another 100,000 in doctor visits by implementing a fitness plan campaign. The system may further determine that the employer will save another 100,000 by switching to a higher-deductible health plan. The system may further determine that the employer will save another 100,000 by switching a particular drug to a generic drug only. Thus, the projected savings 639 may determine a total of 400,000 in projected savings. The projected savings 639 may be further broken down such that the employer can consider implementing some but not all of the recommendations, and have a good understanding of what the bottom-line impact will be by making such decisions.

All of the back-end data analytics are used to generate claim facts 641. As the claim facts 641 are generated, they are stored in database 617 in one or more claim fact data tables. Claim facts 641 are output as actionable data for the employer to use to optimize their healthcare spending. Claim facts 641 may be in any form of actionable data. As one example, a claim fact may be an identified opportunity for savings. As another example, a claim fact may be a recipe for achieving one or more pieces of identified savings. As another example, a claim fact may be a piece of information that is valuable for the employer to know (e.g., “your healthcare spending increases 2.5× in November because of doctor visits related to the flu”). Claim facts 641 may be generated using machine-learning by training the machine-learning model to identify savings opportunities in the data based on previously identified savings opportunities. A user of the system may input a data set of claims and train the system on desired outcomes. Once the system is trained for a machine-learning model, the system can apply the trained machine-learning module to later-imported data to identify inefficiencies in the later-imported data without the need for human review. For example, a user may train a machine-learning model to identify duplicate claims, and then use that trained machine-learning model to identify any incoming duplicate claims in near-real-time as they are imported.

The back-end system may further include a data export system 643. The data export system 643 may be communicatively coupled to the database 617 such that it can export any information in the database 617 to external sources, for example through the web interface 613.

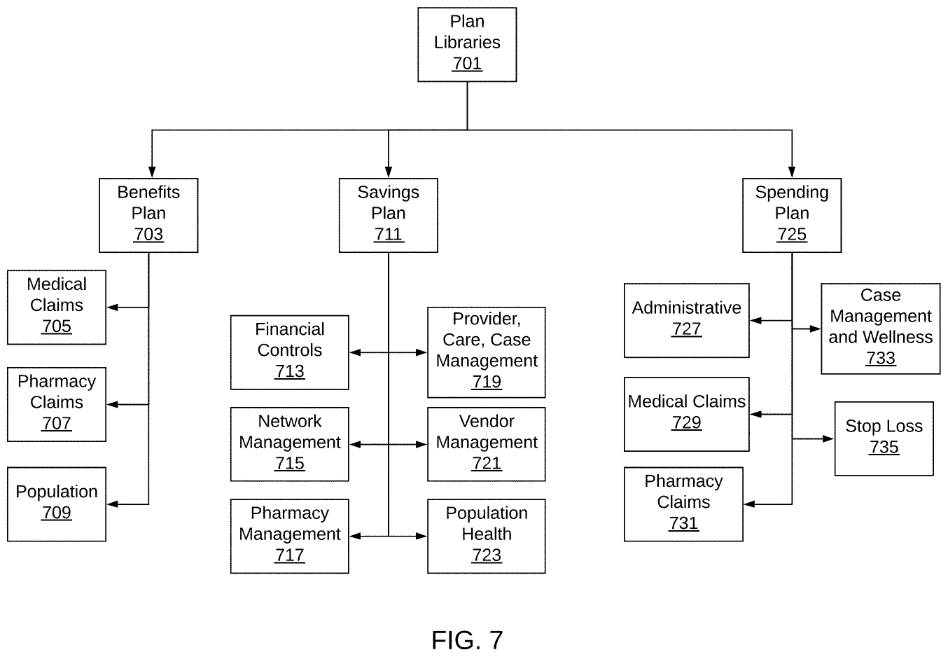

FIGS. 7-11 relate to organization of data within the system described herein. As explained above, the incoming data is stored in the database and may be cleaned and/or standardized during the intake process.

FIG. 7 depicts a hierarchical organizational structure for plan libraries used in an exemplary embodiment of the data analytics framework for identifying a savings opportunity for self-funded healthcare payers.

As shown in FIG. 7, a plan library 701 comprises a benefits plan 703, a savings plan 711, and/or a spending plan 725. The benefits plan 703 may include medical claims 705, pharmacy claims 707, and/or population information 709. The savings plan 711 may include financial controls 713, network management 715, pharmacy management 717, provider care and case management 719, vendor management 721, and population health 723. The spending plan 725 may include administrative data 727, medical claims 729, pharmacy claims 731, case management and wellness 733, and stop loss 735. Information relating to plan library 701 is stored in a database, as described in the context of FIG. 6.

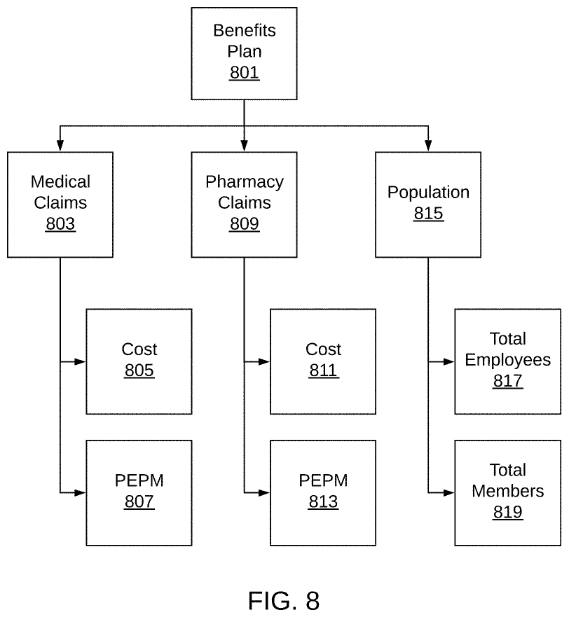

FIG. 8 depicts a hierarchical organizational structure for benefits plan used in an exemplary embodiment of the data analytics framework for identifying a savings opportunity for self-funded healthcare payers.

As shown in FIG. 7, the plan library 701 includes a benefits plan 703. The structure of the benefits plan information is shown in further detail in FIG. 8. The benefits plan 801 comprises medical claims 803, pharmacy claims 809, and/or population information 815. Medical claims 803 comprise cost information 805 and/or per-employee-per-month (“PEPM”) cost information 807. Pharmacy claims 809 comprise cost information 811 and PEPM cost information 813. Population information 815 comprises total employees 817 and total members 819.

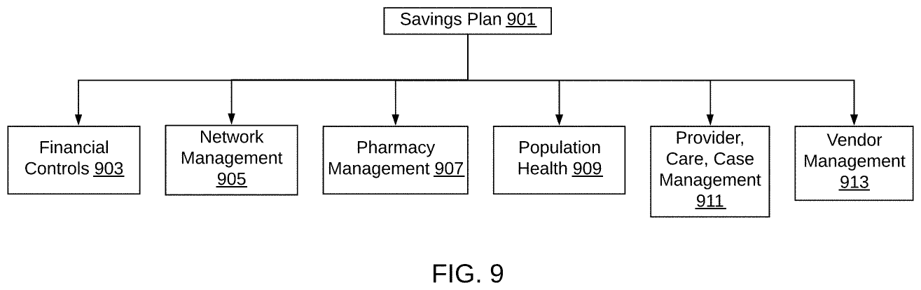

FIG. 9 depicts a hierarchical organizational structure for savings plan used in an exemplary embodiment of the data analytics framework for identifying a savings opportunity for self-funded healthcare payers.

As shown in FIG. 7, the plan library 701 includes a savings plan 711. The structure of the savings plan information is shown in further detail in FIG. 9. The savings plan structure and hierarchy may contain all data for potential savings for a client. The savings plan 901 may comprise financial controls 903, network management 905, pharmacy management 907, population health 909, provider care and case management 911, and/or vendor management 913. The savings plan 901 may display relevant data for paid claims and person information based on actual numbers as well as projected numbers. In one embodiment, the actual data may be processed from the start of a given fiscal year. In one embodiment, the projections may be based on analytic formulas, competitive comparisons, and/or additional information, events, or actions processed within the system.

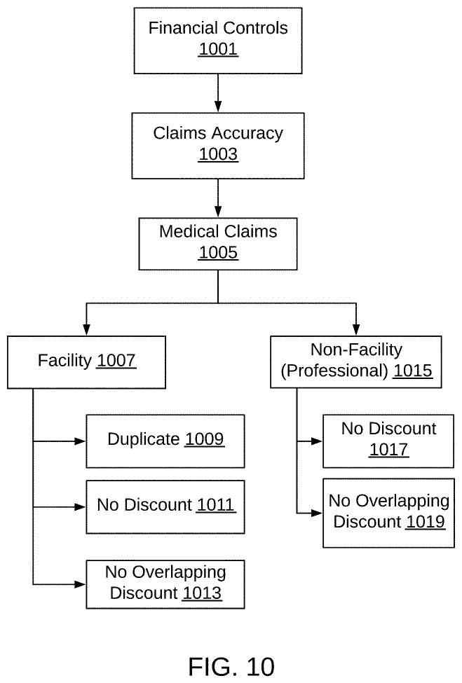

FIG. 10 depicts a hierarchical organizational structure for financial controls used in an exemplary embodiment of the data analytics framework for identifying a savings opportunity for self-funded healthcare payers.

As shown in FIG. 9, the savings plan 901 includes financial controls 903. The structure of the financial controls is shown in further detail in FIG. 10. The financial controls 1001 comprises claims accuracy information 1003. The claims accuracy information 1003 comprises medical claims 1005. The medical claims 1005 comprise facility claims 1007 and non-facility (professional) claims 1015. The facility claims 1007 include duplicate information 1009, no-discount information 1011, and no-overlapping discount 1013. The non-facility claims 1015 include no-discount information 1017 and no-overlapping discount 1019. The duplication 1009, no-discount 1011, no-overlapping discount 1013, no-discount 1017, and no-overlapping discount 1019 may be used to identify savings opportunities. For example, medical claims 1005 that are identified as duplicate 1009 claims may be followed up on to be resolved so that the payer does not pay them twice. Similarly, medical claims 1005 that are identifies as no-discount 1011 and/or no-discount 1015 may be followed up on to allow for negotiation of a discount.

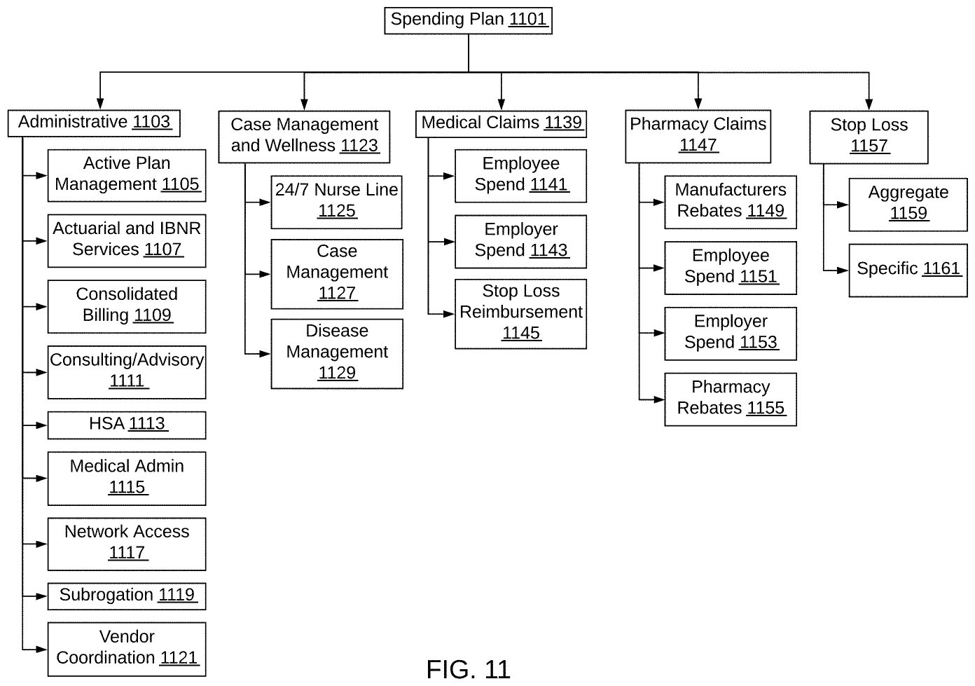

FIG. 11 depicts a hierarchical organizational structure for spending plan used in an exemplary embodiment of the data analytics framework for identifying a savings opportunity for self-funded healthcare payers.

As shown in FIG. 7, the plan library 701 includes a spending plan 725, which comprises five elements. The structure of the five elements of the spending plan is shown in further detail in FIG. 11. Spending plan 1101 comprises administrative information 1103, case management and wellness information 1123, medical claims information 1139, pharmacy claims 1147, and stop loss 1157. The administrative information 1103 comprises an active plan management 1105, actuarial and incurred-but-not-reported (“IBNR”) services 1107, consolidated billing services 1109, consulting/advisory services 1111, health savings account (“HSA”) services 1113, medical administrative services 1115, network access 1117, subrogation 1119, and vendor coordination 1121. The case management and wellness 1123 may comprise 24/7 nurse line 1125, case management 1127, and disease management 1129. The medical claims 1139 comprises employee spend 1141, employer spend 1143, and stop-loss reimbursement 1145. The pharmacy claims 1147 comprises manufacturers rebates 1149, employee spend 1151, employer spend 1153, and pharmacy rebates 1155. The stop loss 1157 includes aggregate information 1159 and specific information 1161.

The information and hierarchies described in FIGS. 7-11 above are stored in a database as described above. The information is maintained with multiple associations in the database. The associations allow the system's back-end data analytics to perform the analysis described herein to identify opportunities for improvement and arrive at actionable claim facts.

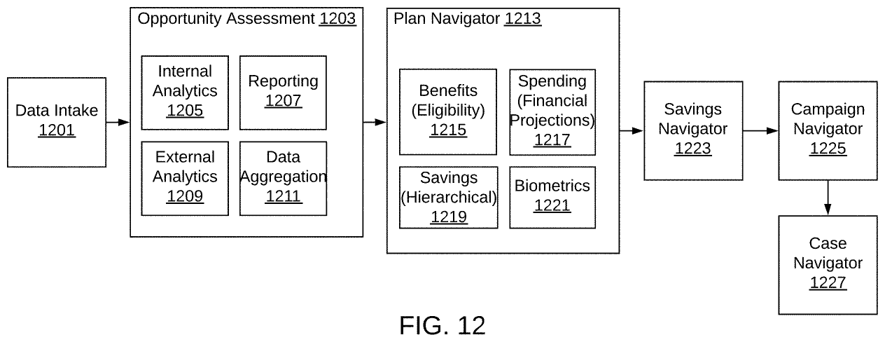

FIG. 12 depicts an exemplary structure of the data analytics framework for identifying a savings opportunity for self-funded healthcare payers.

As shown in FIG. 12, the back-end data-processing system includes a data intake utility 1201, opportunity assessment system 1203, plan navigator 1213, savings navigator 1223, campaign navigator 1225, and case navigator 1227. The data intake utility 1201 connects to external data sources and pulls data from those external data sources into the system. Each of these elements of the back-end data-processing system may be implemented by a processor in a cloud server or spread across multiple cloud servers. As part of the data intake process, the incoming data may be cleaned so that it is easier to work with in the system. For example, formats may be standardized, missing information may be filled in where possible, data may be grouped/classified, etc. The data intake utility 1201 stores the data in a database so that further analysis can be performed by the opportunity assessment system 1203. For example, as incoming data is brought into the system and cleaned, it is stored in a database where it can be analyzed as part of opportunity assessment 1203.

The opportunity assessment system 1203 may comprise internal analytics 1205, reporting 1207, external analytics 1209, and/or data aggregation 1211. The opportunity assessment system 1203 may analyze the data stored in the database for an employer to determine savings opportunities based on the stored data. The opportunities may be identified manually by an administrative user of the system, or they may be identified using machine learning and/or artificial intelligence. The opportunities may be identified using a recipe, which is a set of conditions that leads to a particular output. For example, a recipe may indicate that all claims of a particular type, time frame, and dollar amount be singled out for active follow-up. The opportunity assessment system 1203 is communicatively coupled to the plan navigator 1213 such that the plan navigator 1213 uses the information from the opportunity assessment 1203. The opportunity assessment system 1203 may provide actionable data to users of the system that can be used to achieve the potential savings. For example, the actionable data may include a list of specific recommendations relating to various employers and/or service providers, such as a list of five actions that the self-funded employer may implement to realize the savings identified as part of opportunity assessment 1203.

The plan navigator 1213 may comprise benefits eligibility 1215, spending projections 1217, savings 1219, and biometrics 1221. These blocks allow a user of the system to navigate the various information in the database and see the potential results to benefits, spending, and savings that may be achieved by implementing actionable data from the system. The plan navigator 1213 may be communicatively coupled to the savings navigator 1223. The savings navigator 1223 allows users of the system to view possible projected savings and track the actual savings against the possible projected savings. The plan navigator 1213 may be communicatively coupled to savings navigator 1223. The savings navigator 1223 allows a user of the data analytics framework for identifying a savings opportunity for healthcare payers to view actual savings, projected savings, or both. The savings shown by the savings navigator 1223 may be further sub-divided into where the actual/projected savings have come from and/or what the savings can be attributed to (e.g., benefits, spending, claims, pharmacy, etc.). In other words, this provides the user with the ability to navigate or “drill-down” to increasingly finer levels of detail.

The savings navigator 1223 may be communicatively coupled to the campaign navigator 1225. As explained above, actionable insights are generated based on the data in the database, and those actionable insights may be managed a groups as part of a larger campaign The campaign navigator 1225 allows a user of the system to navigate a campaign to see the details of the campaign, such as employee affected by the campaign, specifics on how to implement the campaign (e.g., changing from Pharmacy A to Pharmacy B, implementing an exercise plan, etc.), the projected savings resulting from implementation of the campaign, and/or the actual savings that have already resulted from implementation of the campaign. The campaign navigator 1225 may be communicatively coupled to the case navigator 1227. The case navigator 1227 allows a user of the system to navigate individual cases or groups of cases to see details of the case, such as employees affected, relevant claims in the system, projected savings from the case, and/or actual savings from the case. Individual cases or groups of cases may be part of one or more of the campaigns, which are managed by the campaign navigator 1225.

The descriptions, figures, and examples provided above are illustrative and are not to be construed as limiting. Nor is the disclosure meant to be limited to the embodiments described in this specification. Specific details are described to provide a thorough understanding of the disclosure; however, in certain instances, well-known or conventional details have not been described to avoid obscuring the description. Modifications/variations will be apparent to those of ordinary skill in the art without departing from the scope and spirit of the described embodiments.

The terms used in this disclosure generally have their ordinary meanings in the art, within the context of the disclosure, and in the specific context where each term is used. The technical and scientific terms used in this disclosure have the same meaning as commonly understood by one of ordinary skill in the art to which this disclosure pertains. In the case of conflict, this document controls. Alternative language and synonyms may be used for the terms discussed herein, nor is any special significance to be placed upon whether or not a term is elaborated or discussed herein. Use of a synonym does not exclude the use of other synonyms.

The singular forms “a,” “an,” and “the” are intended to include the plural forms as well, unless the context clearly indicates otherwise. The terms “comprises” and “comprising” specify the presence of the thing (e.g., function, element, step, etc.) stated but do not preclude the presence of additional things.

The functionalities discussed in this disclosure may be executed by a computer system or other type of machine that stores and executes a set of instructions perform the functionalities. The machine may operate as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, a smartphone, an iPhone, an iPad, an Android-based device, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

The methods disclosed herein may be implemented on purpose-built devices such as a custom-built device with assembled hardware or the like. Additionally, the methods and systems disclosed herein may be implemented on existing RF communications devices that utilize communication modules embodying Wi-Fi®, Bluetooth®, Bluetooth® Low Energy, cellular long-term evolution (LTE®), or many other communications systems and devices.

Aspects of the present invention may be implemented as a system, method or computer program product. They may be implemented as an entirely hardware embodiment, an entirely software embodiment (including firmware, resident software, micro-code, etc.) or an embodiment combining software and hardware aspects that may all generally be referred to herein as a “circuit,” “module” or “system.” Aspects of the present invention may be implemented as a computer program product embodied in one or more computer-readable medium(s) storing computer-readable program code. The terms “machine-readable medium” and “machine-readable storage medium” may include a single medium or multiple media (e.g., a centralized or distributed database, and/or associated caches and servers) that store one or more sets of instructions. These terms may include any medium that is capable of storing, encoding or carrying a set of instructions for execution by the machine and that cause the machine to perform any one or more of the methodologies of the presently disclosed technique and innovation.

Any combination of one or more computer-readable medium(s) may be utilized. The computer-readable medium may be a computer-readable signal medium or a computer-readable storage medium (such as non-transitory computer-readable storage media). A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer-readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Kotlin®, OCaml®, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed.

What is claimed is:

1. A method of clearing electronic transactions through a network for a self-funded payer, the method comprising:
acquiring healthcare data from a data source,
wherein the healthcare data is acquired using a data intake utility by connecting the data intake utility to the data source over the network;
preparing the acquired healthcare data,
wherein preparing the acquired healthcare data includes cleaning the acquired healthcare data;
analyzing the acquired healthcare data to identify an insight based on the acquired healthcare data;
organizing insights based on the acquired healthcare data; and
formulating a data model based on the insights.

2. The method of claim 1, further comprising applying blockchain technology to the formulated data model.

3. The method of claim 1, wherein cleaning the acquired healthcare data includes transforming at least some of the acquired healthcare data into a format that is different than the format in which the healthcare data was acquired.

4. The method of claim 1, wherein the different format is a standardized format.

5. The method of claim 1, wherein the organizing insights is performed using machine learning to identify trends in the acquired healthcare data.

6. The method of claim 1, wherein the data model identifies a savings opportunity based on the organized insights and the opportunity is quantified into a numerical value based on the acquired healthcare data and the data model.

7. A method of identifying a savings opportunity in healthcare data for a self-funded payer, the method comprising:
receiving, via a data intake utility, healthcare data from an external data source,
wherein the healthcare data includes patient health data, and
wherein the healthcare data is received over a network connection that connects the data intake utility to the external data source;
storing the received healthcare data in a database;
performing data analytics on the received healthcare data, wherein the data analytics includes:
a benefits analysis to determine projected benefits;
a spending analysis to determine projected spending; and
a savings analysis to determine projected savings;
determining a claim fact based on the data analytics performed on the received healthcare data; and
generating a savings recipe for realizing a savings opportunity based on the determined claim fact.

8. The method of claim 7, wherein determining the claim fact includes checking for claim accuracy of a received medical claim.

9. The method of claim 7, wherein determining the claim fact includes checking for contract compliance of a received medical claim.

10. The method of claim 7, wherein the received healthcare data is cleaned as part of storing the received healthcare data in the database.

11. The method of claim 7, wherein the data analytics is performed using machine learning to identify trends in the received healthcare data.

12. The method of claim 7, wherein the data analytics includes performing claim reconciliation on a received medical claim.

13. The method of claim 7, wherein the database includes a plan library that comprises a benefits plan, a savings plan, and a spending plan.

14. A system for identifying a savings opportunity in healthcare data for a self-funded payer, the system comprising:
an interface layer, wherein the interface layer includes a data intake utility configured to connect to an external data source;
a database; and
a data analytics server, the server comprising a processor configured for:
receiving, via the data intake utility, healthcare data from the external data source,
wherein the healthcare data includes patient health data, and
wherein the healthcare data is received over a network connection that connects the data intake utility to the external data source;
storing the received healthcare data in the database;
performing data analytics on the received healthcare data, wherein the data analytics includes:
a benefits analysis to determine projected benefits;
a spending analysis to determine projected spending; and
a savings analysis to determine projected savings;
determining a claim fact based on the data analytics performed on the received healthcare data; and
generating a savings recipe for realizing a savings opportunity based on the determined claim fact.

15. The system of claim 14, wherein determining the claim fact includes checking for claim accuracy of a received medical claim.

16. The system of claim 14, wherein determining the claim fact includes checking for contract compliance of a received medical claim.

17. The system of claim 14, wherein the received healthcare data is cleaned as part of storing the received healthcare data in the database.

18. The system of claim 14, wherein the data analytics is performed using machine learning to identify trends in the received healthcare data.

19. The system of claim 14, wherein the data analytics includes performing claim reconciliation on a received medical claim.

20. The system of claim 14, wherein the database includes a plan library that comprises a benefits plan, a savings plan, and a spending plan.
